(19) United States
(12) Patent Application Publication
(10) Pub. No.: US 2013/0330087 A1
(43) Pub. Date: Dec. 12, 2013

(54) METHOD AND APPARATUS FOR REDUCING INTERFERENCE DURING UPSTREAM MICRONODE TRANSMISSIONS

(71) Applicants: Mark O. Vogel, Statesville, NC (US); Ronald Howard Diego, Boca Raton, FL (US); Stephen L. Maynard, Arvada, CO (US); Tho Autruong, Boulder, CO (US)

(72) Inventors: Mark O. Vogel, Statesville, NC (US); Ronald Howard Diego, Boca Raton, FL (US); Stephen L. Maynard, Arvada, CO (US); Tho Autruong, Boulder, CO (US)

(21) Appl. No.: 13/492,960

(22) Filed: Jun. 11, 2012

(51) Int. Cl. H04B 10/00

(52) U.S. Cl. 398/116

(57) ABSTRACT

A micronode includes an electrical port connectable to a downstream device, an optical port connectable to a head end having an upstream controller and an electro-optical converter connected to the electrical port and to the optical port and configured to convert electrical signals received from the downstream device at the electrical port to optical signals and to convert optical signals received from the head end via the optical port to electrical signals. The micronode also includes an addressable controller configured to receive a micronode polling request from the upstream controller and to determine when the downstream device is sending signals to the head end and begin a response to the micronode polling request in response to a determination that the downstream device is transmitting information to the head end. Also, an associated method of controlling the micronode.

### FIELD OF THE INVENTION

The present invention is directed to a micronode that transmits status information to an upstream controller in response to a polling request and to a method of controlling the micronode, and, more specifically, to a micronode that transmits status information to an upstream controller only when a device downstream of the micronode is sending information upstream via the micronode and to a method of controlling the micronode.

### BACKGROUND OF THE INVENTION

Radio frequency over glass (RFoG) optical networks use optical fibers to carry bi-directional data between an upstream head end and a plurality of end users. Individual optical fibers typically terminate at an optical network unit (ONU) that serves one or more customer locations, and these ONU's may be referred to as micronodes. Each micronode includes an opto-electrical converter for converting optical signals from the head end to electrical signals that can be sent to customer premises device (e.g., a cable modem or set-top box) and an electro-optical converter that converts electrical signals from the customer premises device to optical signals for transmission to the head end.

Conventional micronodes are essentially invisible to the head end and the customer premises device; that is, to the customer premises device, the electrical signals from the micronode appear the same as if they had been transmitted from the head end as electrical signals over a length of coaxial cable. It is sometimes desirable to control the micronodes remotely and/or to obtain status information from the micronodes, which may be information about the micronode itself or about devices attached to the micronode. To this end, the micronodes must be addressable so that signals from the head end can be sent to an appropriate micronode, and the micronodes must be able to transmit signals to the head end with data regarding the micronode.

All downstream transmissions are controlled by a controller at the head end, and that controller can ensure that downstream signals are sent in a manner that does not cause interference. However, upstream signals from customer premises devices, such as a cable modems or set-top boxes or from the micronodes themselves are not under the control of a single controller. Multiple micronodes may therefore receive electrical signals from customer premises devices and send upstream optical signals having wavelengths and polarizations close enough that they will beat against one another and create noise, referred to as “optical beat interference” or “OBI” in the return path spectrum. This can result in packet errors or even worse it can temporarily impair all communications in the return path.

Cable modems and set-top boxes avoid this problem by operating under a communications standard such as Data Over Cable Service Interface Specification (DOCSIS). This protocol assigns timeslots or otherwise determines when various devices can transmit in an upstream direction. A plurality of customer premises devices transmitting to a headed can generally avoid interference by following this standard. Micronodes, however, do not use this standard and cannot determine whether a transmission will interfere with a transmission from another micronode or another customer premises device on the network. One method of addressing this problem would be to assign the micronodes timeslots or otherwise design the micronodes to work within a standard such as DOCSIS. However, revising such a standard is complicated, and assigning additional time slots to micronodes would reduce the time slots available for the customer premises devices to use. In addition, DOCSIS includes many features that are not required by micronodes, and equipping micronodes with DOCSIS capabilities would add significantly to their cost. It would therefore be desirable to provide a micronode capable of transmitting information to a head end controller in a manner that avoids such interference and avoids the need to modify existing standards.

### SUMMARY OF THE INVENTION

This problem and others are addressed by embodiments of the present invention, a first aspect of which comprises a micronode that includes an electrical port connectable to a downstream device, an optical port connectable to a head end having an upstream controller via an optical link, an electro-optical converter connected to the electrical port and to the optical port and configured to convert electrical signals received from the downstream device at the electrical port to optical signals and send the optical signals to the head end via the optical port and to convert optical signals received from the head end via the optical port to electrical signals and to send the electrical signals to the downstream device via the first port, and an addressable controller configured to receive a micronode polling request from the upstream controller and to determine when the downstream device is sending signals to the head end. The addressable controller is configured to begin a response to the micronode polling request in response to a determination that the downstream device is transmitting information to the head end and to cease the response to the micronode polling request in response to a determination that the electro-optical converter has stopped transmitting the information to the head end.

Another aspect of the invention comprises a method of obtaining information from a micronode configured to perform electro-optical conversion between a downstream electrical device and an upstream optical controller. The method includes sending a micronode polling request to the micronode and the micronode beginning a response to the micronode polling request in response to a determination that the electrical device is transmitting information to the head end and the micronode ceasing the response to the micronode polling request before the response is complete in response to a determination that the electrical device is not transmitting information to the head end.

A further aspect of the invention comprises a micronode that includes an electrical port connectable to a downstream device, an optical port connectable to a head end having an upstream controller via an optical link, and an electro-optical converter connected to the electrical port and to the optical port and configured to convert electrical signals received from the downstream device at the electrical port to optical signals and send the optical signals to the head end via the optical port and to convert optical signals received from the head end via the optical port to electrical signals and to send the electrical signals to the downstream device via the first port. The micronode also includes an addressable controller configured to receive a micronode polling request from the upstream controller and to determine when the downstream device is sending signals to the head end. During a first time period after the micronode polling request is received, the addressable controller is configured to respond to the micronode polling request in response to a determination that the downstream device is transmitting information to the head end, and, in the absence of a determination that the downstream device is transmitting information to the head end during the first time period, to respond to the micronode polling request during a second time period after the first time period.

### BRIEF DESCRIPTION OF THE DRAWINGS

These and other aspects and features of embodiments of the invention will be better understood after a reading of the following detailed description together with the attached drawings, wherein:

FIG. 1 is a schematic illustration of a head end and an addressable micronode according to an embodiment of the present invention.

FIG. 2 is a schematic illustration of a message sent from the head end to the addressable micronode.

FIG. 3 is a schematic illustration of a message sent from the addressable micronode to the head end.

FIG. 4 is a flowchart illustrating a method according to an embodiment of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

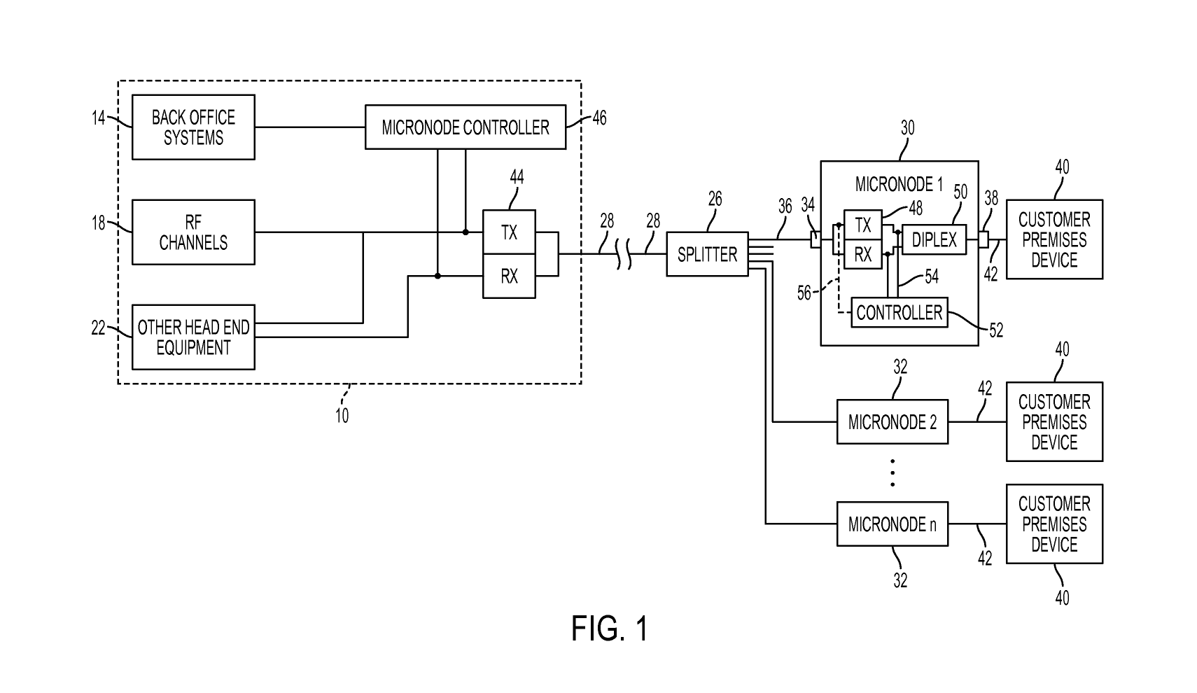

FIG. 1 illustrates an RFoG network that includes a head end 10. Head end 10 includes back office systems 14, a source of RF channels 18, other head end equipment 22 and the head end 10 is connected to a splitter 26 by a first optical fiber 28. FIG. 1 also illustrates a first micronode 30 and second and third additional micronodes 32. Any number of additional micronodes 32 may be provided, and these additional micronodes are substantially identical to the first micronode 30 and operate in substantially the same manner.

The first micronode 30 includes a first, optical, port 34 connected to the splitter 26 by a second optical fiber 36 and a second, electrical port 38 connected to a customer premises device 40, such as a cable modem or set-top box, by a coaxial cable 42. The head end 10 will be described herein as the “upstream” end of the network, and signals propagating toward the head end 10 will be described as moving in the “upstream” direction. The first micronode 30 and the customer premises device 40 are at the downstream end of the network, and signals propagating toward the customer premises devices will be described as moving in the “downstream” direction.

The head end 10 includes an electro-optical converter 44 for converting electrical signals, from RF channels 18, for example, into optical signals and for converting optical signals received at the head end 10 into electrical signals for use by other head end equipment 22. Such electro-optical converters may comprise a first component for converting electrical signals to optical signals (an electrical-to-optical converter) and a second component for converting optical signals to electrical signals (an optical-to-electrical converter); however, such converters are conventional and well known are illustrated herein as a single functional component for performing both types of conversion. A reference to an electro-optical converter therefore refers to a device that performs one or both of electrical-to-optical or optical-to-electrical signal conversion. The head end 10 further includes an upstream controller 46 which communicates with the first micronode 30 and the additional micronodes 32.

The first micronode 30 includes an electro-optical converter 48 for converting electrical signals received at the electrical port 38 into optical signals and for converting optical signals received at the optical port 34 into electrical signals. As with the electro-optical converter 44 in the head end 10, the electro-optical converter 48 in the first micronode 30 is shown as a single element for ease of illustration. The first micronode 30 also includes a diplexer 50 for handling two-way communication between the customer premises device 40 and the electro-optical converter 48 and a controller 52 that monitors signals at the first micronode 30 and communicates with the upstream controller 46 in the head end 10. Except for the presence of the controller 52 and its associated connections, the first micronode 30 is essentially a conventional micronode.

In operation, signals from the RF channels 18 are converted from electrical signals to optical signals by the electro-optical converter 44 at the head end and sent to one or more of the first micronode 30 and the other micronodes 32 via the first optical fiber 28 and the splitter 26. These optical signals are converted to electrical signals by the electro-optical converters 48 at the first micronode 30 and other micronodes 32 and output through the coaxial cables 42 connected to the electrical ports 38 to the associated customer premises devices 40. Electrical signals from the customer premises device 40, cable modems and/or set-top boxes, for example, are sent to the first micronode 30 for conversion to optical signals which are then sent to the head end 10 via the splitter 26.

Upstream and downstream optical signals on first optical fiber 28 are generally sent at different wavelengths, for example 1550 nm downstream and 1310 or 1610 nm upstream which prevents interference between the upstream and downstream signals and does not require that the upstream and downstream signals be coordinated. However, upstream communications from various customer premises devices 40 to the head end 10 may occur at the same frequency. Such communication is therefore handled according to a standard or protocol such as DOCSIS which assigns timeslots to each of the customer premises devices 40 or otherwise controls the transmissions of the customer premises devices 40 to ensure that no two customer premises devices attempt to send information to the head end 10 in a manner that causes interference.

Unlike conventional micronodes, the first micronode 30 and the head end 10 can communicate with each other using the upstream controller 46 at the head end 10 and the controller 52 at the first micronode 30. This may allow the head end 10 to configure the first micronode 30 when the first micronode 30 first connects to the network or after an event such as a power failure that requires a micronode reconfiguration and to change various settings of the first micronode 30. In addition, the first micronode 30 can send status information about the first micronode 30 and/or devices such as the customer premises device 40 connected thereto to the head end 10. These are merely examples of the types of information that may be sent between the first micronode 30 and the head end 10 and are not intended to be limiting.

Unlike the customer premises devices 40, the first and other micronodes 30, 32 have no way of synchronizing their upstream transmissions to the head end 10 with each other or with the customer premises devices 40 connected to other micronodes. Thus, for example, it might be possible for the first micronode 30 to send status information to the head end 10 at the same time one of the other micronodes 32 or the customer premises device 40 connected to one of the other micronodes 32 is transmitting data. This can result in optical beat interference if the transmission wavelengths used by the transmitting devices are similar, and may render one or both of the upstream signals unintelligible to the head end 10. To address this problem, the present inventor has determined that the controller 52 at each of the first micronode 30 and other micronodes 32 can monitor the upstream signals being sent from the customer premises device 40 connected thereto and only transmit information from the controller 52 to the upstream controller 46 when the customer premises device 40 connected to that particular micronode is transmitting. This takes advantage of the fact that the customer premises devices 40 know via DOCSIS or another protocol when they are allowed to transmit, and the first micronode 30 or other micronode 32 can send a transmission that, in effect, hides behind this transmission, using a different upstream transmission frequency. The controller 52 can determine when the associated customer premises device 40 is transmitting by monitoring electrical signals being sent to the electro-optical converter 48 by the diplexer 50 using line 54 or, alternately, by monitoring the optical output of the electro-optical converter 48 using an optional line 56.

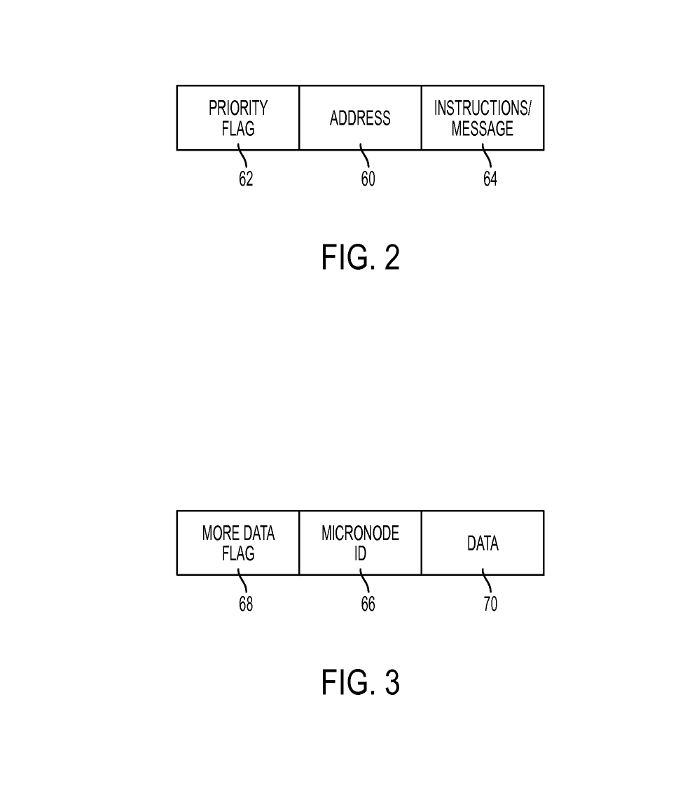

In the preferred embodiment, the controllers 52 in the first micronode 30 and in the other micronodes 32 will only send data to the upstream controller 46 in response to a polling request from the upstream controller 46. If the request from the upstream controller 46 is indicated to be a priority request, by the presence of a flag in the message sent to the first micronode 30, for example, the first micronode 30 will respond to the request immediately, without waiting for a transmission from the attached customer premises device 40 to hide behind. The structure of a downstream message, comprising an address 60, a priority flag 62 and an instruction or message portion 64 is illustrated in FIG. 2. The sending of priority requests will generally be limited to times when the other micronodes 32 have not been queried for a given period of time and are unlikely to be transmitting their own messages to the upstream controller 46. This helps ensure that the response of the first micronode 30 to the priority status request will not result in interference.

Most requests from the upstream controller 46 will not be priority requests and will be handled as follows. When a non-priority polling request is received by the first micronode 30, the first micronode will determine whether it has any status information to send to the upstream controller 46. If there is no data to send, such as when no information has changed since a previous query, the first micronode 30 will respond to the upstream controller with a short message having a first flag set to indicate that no data has changed. Such a message will be sent when the controller 52 determines that the customer premises device 40 is transmitting to the head end, and this no-change status message will generally be shorter than the shortest DOCSIS transmission and be completed before the DOCSIS transmission from the customer premises device 40 is complete. When the customer premises device 40 connected to the first micronode 32 is a cable modem, relatively frequent transmissions from the cable modem to the head end 10 make it likely that the first micronode 30 will have an opportunity to respond to the head end 10 within a relatively short time, 30 seconds, for example. However, if the customer premises device 40 is a set-top box, or if there is no customer premises device 40 connected to the first micronode 30, the head end 10 will likely have to wait more than 30 seconds, potentially indefinitely, for a response from the first micronode 30. The controller 52 at the first micronode 30 is therefore configured to respond to the query from the upstream controller 46 after a fixed time period, such as 30 seconds, even if there is no transmission from the customer premises device 40. While this transmission could produce interference, the likelihood of interference is low because such transmissions should be infrequent. And, when the upstream controller 46 receives a response from the first micronode 30 that is not hiding behind a customer premises device transmission, the upstream controller 46 will know that the first micronode 30 is connected to a customer premises device that is transmitting infrequently or not at all and in response may set a lower polling frequency for the first micronode 30. Alternately, the polling of the first micronode 30 may thereafter take place during a time when all other micronodes are quiet, during or immediately after a designated time for the configuration of new micronodes, for example. If the first micronode 30 responds to such a polling request at the same time as an upstream signal from the associated customer premises device, the upstream controller 46 will know that the associated customer premises device has been reconnected or become active again, and the first micronode 30 may again be polled at the same frequency as the other micronodes 32.

To avoid interference, the first micronode 30 must cease the upstream transmission of data if the data transmission from the customer premises device 40 to the head end 10 ceases. As previously noted, many transmissions from the first micronode 30 will be shorter than the shortest DOCSIS transmission from the customer premises devices 40 and will therefore be completed before the DOCSIS transmission ends. However, some longer transmissions from the first micronode 30 may be longer than the shortest DOCSIS transmissions. Such transmissions from the first micronode 30 should be cut off when the transmission from the customer premises device ends. If a first transmission from the first micronode 30 is cut off, the first micronode 30 may be configured to send its data a second time with the next detected transmission from the customer premises device 40; however, the upstream controller 46 may not be configured to handle a data transmission that arrives too long after a query was sent. Therefore, preferably, the upstream controller 46 will either recognize that a transmission is incomplete and send another status query or, alternately, take no action, and query the first micronode 30 again at a later time, with the expectation that the next response from the first micronode 30 will occur during a DOCSIS transmission that is longer that the previous DOCSIS transmission from the first micronode 30. Many DOCSIS transmissions are longer than the average data transmission from the first micronode 30, and it is reasonable to expect a second or subsequent transmission to be sent behind a sufficiently long DOCSIS transmission on a second or third attempt.

Another method of transmitting data from the first micronode 30 in a time shorter than the shortest DOCSIS transmission is to set a flag in the message from the first micronode 30 to the upstream controller 46 that indicates whether more information remains to be transmitted. A message having a micronode identifier 66, a “more data” flag 68 and a data portion 70 is illustrated in FIG. 3. If the upstream controller 46 sees that this more data flag 68 is set, it will send further queries to the particular micronode until the flag indicates that no further data remains to be transmitted. Preferably, the more data flag 68 will be set to indicate no further data follows when the message includes no data change or when only a single parameter has changed at the first micronode 30. Changes in more than one parameter may cause the more data flag 68 to be set to cause the upstream controller 46 to send additional queries.

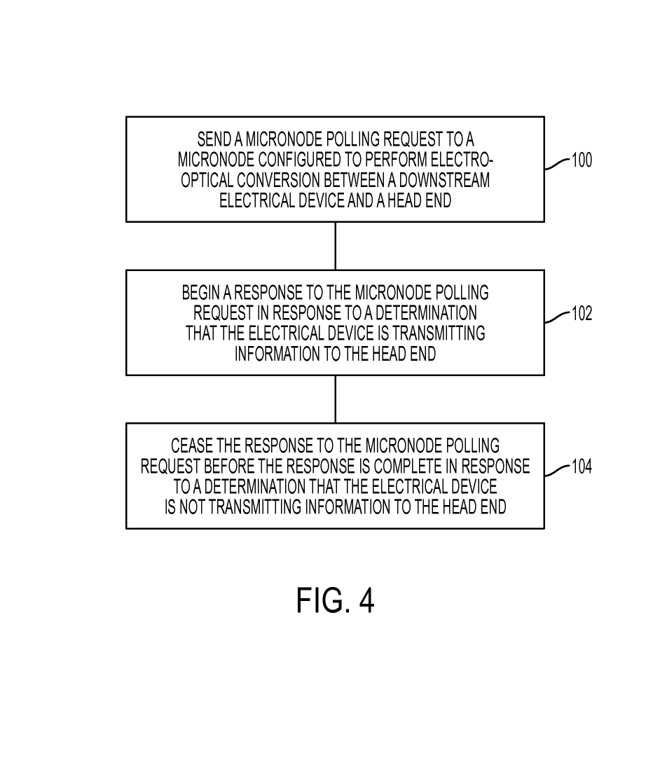

FIG. 4 illustrates a method of obtaining information from a micronode configured to perform electro-optical conversion between a downstream electrical device and an upstream head end that includes a step 100 of sending a micronode polling request to the micronode, a step 102 of the micronode beginning a response to the micronode polling request in response to a determination that the electrical device is transmitting information to the head end, and a step 104 of ceasing the response to the micronode polling request before the response is complete in response to a determination that the electrical device is not transmitting information to the head end.

The present invention has been described herein in terms of one or more presently preferred embodiments. However, modifications and additions to these embodiments may become apparent to those of ordinary skill in the relevant art upon a reading of the foregoing disclosure. It is intended that all such modifications and additions comprise a part of the present invention to the extent they fall within the scope of the several claims appended hereto.

What is claimed is:

1. A micronode comprising:
an electrical port connectable to a downstream device;
an optical port connectable to a head end having an upstream controller via an optical link;
an electro-optical converter connected to the electrical port and to the optical port and configured to convert electrical signals received from the downstream device at the electrical port to optical signals and send the optical signals to the head end via the optical port and to convert optical signals received from the head end via the optical port to electrical signals and to send the electrical signals to the downstream device via the first port; and
an addressable controller configured to receive a micronode polling request from the upstream controller and to determine when the downstream device is sending signals to the head end,
wherein the addressable controller is configured to begin a response to the micronode polling request in response to a determination that the downstream device is transmitting information to the head end and to cease the response to the micronode polling request in response to a determination that the electro-optical converter has stopped transmitting the information to the head end.

2. The micronode according to claim 1, wherein the determination that the downstream device is transmitting information to the head end comprises a determination that the electro-optical controller is sending optical signals to the head end.

3. The micronode according to claim 1, wherein the response to the micronode polling request comprises micronode status information.

4. The micronode according to claim 1, wherein the addressable controller is configured to begin a response to the micronode polling request in the absence of a transmission from the downstream device to the head end a predetermined time after the micronode polling request is received.

5. The micronode according to claim 1, wherein the addressable controller is configured to respond immediately to a polling request from the upstream controller if the polling request is indicated to be a priority polling request.

6. The micronode according to claim 1, wherein the addressable controller is configured to store micronode status information and wherein the addressable controller is configured to send the micronode status information to the upstream controller only in response to a micronode polling request.

7. The micronode according to claim 1, wherein the addressable controller is configured to respond to a micronode polling request with a message, the message having a first flag setting to indicate all data is being sent and a second flag setting to indicate that additional polling is needed.

8. The micronode according to claim 1, wherein downstream device transmits at a first frequency and wherein the addressable controller is configured to send the response to the upstream optical controller using a second frequency different than the first frequency.

9. The micronode according to claim 1,
wherein the micronode controller is configured to store micronode status information and wherein the response comprises at least a portion of the micronode status information and a flag indicating whether more information remains to be sent,
wherein the addressable controller is configured to begin a response to the micronode polling request in the absence of a transmission from the downstream device to the head end a predetermined time after the micronode polling request is received, wherein the addressable controller is configured to respond immediately to a polling request from the upstream controller if the polling request is indicated to be a priority polling request, and
wherein the addressable controller is configured to send the micronode status information to the upstream controller only in response to a micronode polling request.

10. A method of obtaining information from a micronode configured to perform electro-optical conversion between a downstream electrical device and an upstream optical controller, the method comprising:
sending a micronode polling request to the micronode;
the micronode beginning a response to the micronode polling request in response to a determination that the electrical device is transmitting information to the head end; and
the micronode ceasing the response to the micronode polling request before the response is complete in response to a determination that the electrical device is not transmitting information to the head end.

11. The method of claim 10 including beginning the response to the micronode polling request a predetermined time after the micronode polling request is received in the absence of a determination that the electrical device is transmitting information to the head end.

12. The method of claim 11 including the upstream controller reducing a micronode polling frequency if the micronode transmits information to the upstream controller when the electrical device is not transmitting information.

13. The method of claim 10 including beginning the response to the micronode polling request immediately if the micronode polling request is determined to be a priority micronode polling request.

14. The method of claim 10 including the upstream controller determining that the micronode response is incomplete and in response to the determining that the micronode response is incomplete, sending an additional polling request to the micronode.

15. The method of claim 10, wherein the response includes data and a flag settable to indicate whether more data remains to be sent and wherein the upstream controller sends an additional polling request after receiving a response with the flag set to indicate more data remains to be sent.

16. The method of claim 10, wherein the micronode is connected to a network including a plurality of additional micronodes, and wherein the micronode is configured to respond immediately to a polling request indicated to be a priority polling request, and including waiting for the plurality of additional micronodes to stop transmitting before sending the micronode the priority polling request.

17. The method of claim 16 including the upstream controller sending only priority polling requests to the micronode if the micronode transmits information to the upstream controller when the electrical device is not transmitting information.

18. The method of claim 10, including beginning the response to the micronode polling request a predetermined time after the micronode polling request is received in the absence of a determination that the electrical device is transmitting information to the head end, and
including the upstream controller reducing a micronode polling frequency if the micronode transmits information to the upstream controller when the electrical device is not transmitting information; and
including beginning the response to the micronode polling request immediately if the micronode polling request is determined to be a priority micronode polling request.

19. A micronode comprising:
an electrical port connectable to a downstream device;
an optical port connectable to a head end including an upstream controller via an optical link;
an electro-optical converter connected to the electrical port and to the optical port and configured to convert electrical signals received from the downstream device at the electrical port to optical signals and send the optical signals to the head end via the optical port and to convert optical signals received from the head end via the optical port to electrical signals and to send the electrical signals to the downstream device via the first port; and
an addressable controller configured to receive a micronode polling request from the upstream controller and to determine when the downstream device is sending signals to the head end,
wherein, during a first time period after the micronode polling request is received, the addressable controller is configured to respond to the micronode polling request in response to a determination that the downstream device is transmitting information to the head end and in the absence of a determination that the downstream device is transmitting information to the head end during the first time period, to respond to the micronode polling request during a second time period after the first time period.

20. The micronode according to claim 19 wherein the addressable controller is configured to cease the response to the micronode polling request before the response to the micronode polling request is complete if the downstream device stops transmitting information to the head end.
